(19) United States
(12) Patent Application Publication
(10) Pub. No.: US 2023/0146762 A1
(43) Pub. Date: May 11, 2023

(54) ELECTRONIC TRAINING COLLAR AND BASE SYSTEM

(71) Applicants: Patrick O'Banion, Midlothian, TX (US); Lauren O'Banion, Midlothian, TX (US)

(72) Inventors: Patrick O'Banion, Midlothian, TX (US); Lauren O'Banion, Midlothian, TX (US)

(21) Appl. No.: 17/521,787

(22) Filed: Nov. 8, 2021

(51) Int. Cl. A01K 27/00; A01K 15/02

(52) U.S. Cl. CPC A01K 27/009; A01K 15/023

(57) ABSTRACT

An electronic training collar and base system using at least one electronic training collar in combination with at least one base to prevent the pet from entering the area around the base. The electronic training collar has a housing with a receiver, a shocking component, an audio alarm component, and a vibrating signal component. The audio alarm component is adapted to emit a tone when activated, the vibrating signal component is adapted to emit a vibration when activated, and the shocking component is adapted to emit a shock when activated. A base has a transmitter that emits a signal which is received by the receiver of the electronic training collar when a pet wearing the electronic training collar is within a range of the base effectively activating either the shocking component, the audio alarm component, the vibrating signal component or a combination of the components. The base may be shaped as a mat which is durable and hand washable. A beacon scanner and beacon transmitter could be used in place of the receiver and transmitter respectively.

### TECHNICAL FIELD

The present invention relates generally to the field of pet behavior modification using at least one electronic training collar in combination with at least one base to prevent the pet from entering the area around the base.

### BACKGROUND

The following is a tabulation of some prior art that presently appears relevant:

### U.S. Patents

| Patent Number | Kind Code | Issue Date | Patentee |
|---|---|---|---|
| U.S. Pat. No. 6,047,664 | A | 2000 Apr. 11 | Lyerly |
| U.S. Pat. No. 6,615,770 | B2 | 2003 Sep. 9 | Patterson et al. |
| U.S. Pat. No. 6,651,592 | B2 | 2003 Nov. 25 | Maddox et al. |
| U.S. Pat. No. 8,186,310 | B1 | 2012 May 29 | Smith |
| U.S. Pat. No. 9,125,380 | B2 | 2015 Sep. 8 | Deutsch |
| U.S. Pat. No. 9,538,728 | B2 | 2017 Jan. 10 | Womble et al. |
| U.S. Pat. No. 10,058,072 | B2 | 2018 Aug. 28 | Jin |

### U.S. Patent Application Publications

| Publication Nr. | Kind Code | Publ. Date | Applicant |
|---|---|---|---|
| U.S. 2014/0331942 | A1 | 2014 Nov. 13 | Sarazyn |
| U.S. 2015/0075446 | A1 | 2015 Mar. 19 | Hu |
| WO 2006/019488 | A1 | 2006 Feb. 23 | Kates |
| WO 2011/032055 | A3 | 2011 Mar. 17 | Hardi et al. |

Pet owners have many reasons to want their pets to stay out of various areas. Pets could eat another pet's food which could be medicated. With finicky pets, it might be difficult to know if the pet ate its own food or if another pet ate it instead. Dogs might try to eat a cat's food, and the owner might not want to feed the cat on a cabinet or table. Pets could be present at the table when people are eating. The prior art has many examples of ways to overcome this problem, but none as optimal as the current invention.

Electronic collars are well known in the prior art. For example, U.S. Pat. No. 6,047,664 (2000) to Lyerly. U.S. Pat. No. 8,186,310 (2012) to Smith. and U.S. Patent Application Publication U.S. 2014/0331942 to Sarazyn all disclose electronic collars but do not include a base or other means to delineate a protected area. U.S. Pat. No. 8,186,310 (2012) to Smith shows a second collar which causes the first collar to activate, so that, for example, a dog could wear the first collar and the cat could wear the second collar and the dog would receive a shock if it came within range of the cat. This patent is limited by the claims to use with cats and dogs.

An electronic collar has been paired with a smart phone in Patent Application Publication 2015/0075446 (2015) to Hu. In this invention, the pet is kept within range of the smartphone, but this again would not help with keeping a pet away from a defined area.

An electronic device has been disclosed that uses motion detection to keep a pet out of a protected area. U.S. Pat. No. 6,615,770 (2003) to Patterson et al. proposes using sound, heat, vibration, and motion detectors to determine that a pet is in a protected area and then produces a signal such as the owner's voice, other tones, or bursts of light to scare the pet away. This has the disadvantage that it scares or startles the pet so that it could not eat. This device also does not use a collar and thus there is no way to distinguish which pet is in the protected area.

International Publication Number WO 2011/032055 (2011) to Hardi et al., shows a base station and pet tags or electronic collars. Hardi et al., shows a remote controller that delivers audible pet training instructions but does not include any shock or other deterrent measures. This would not solve the problem of one dog eating another dog's food.

Several types of automatic feeder mechanisms have been disclosed in the prior art, for example, U.S. Pat. No. 6,651,592 (2003) to Maddox et al., U.S. Pat. No. 9,125,380 (2015) to Deutsch, U.S. Pat. No. 9,538,728 (2017) to Womble et al., U.S. Pat. No. 10,058,072 (2018) to Jin, and International Publication Number WO 2006/019488 (2006) to Kates. These may include a collar or not, but all have the limitation that the food would have to be put in a specialized automatic feeder. This would only work for dry food, not canned. All of these automatic feeders have the drawback that the food could become stuck in the mechanism and the pet would not get fed. Also these have the drawback that the pet would have to eat out of a specialized feeder and could not use its own bowl. This could be a drawback in particular for cats who sometimes need a bowl of a particular elevation and angle so that they don't vomit their food.

### SUMMARY OF THE EMBODIMENTS

In a first embodiment of an electronic collar and base system the base has a power source, a microprocessor, and a transmitter. The electronic collar has a collar housing which contains a power source, a microprocessor, a receiver, a shock component, an audio alarm component, and a vibrational signal component.

In a second embodiment of an electronic collar and base system the base has a power source and a beacon transmitter. The electronic collar has a collar housing which contains a power source, a microprocessor, a beacon scanner, a shock component, an audio alarm component, and a vibrational signal component.

A third embodiment of an electronic collar and base system has a base that is shaped like a durable, hand washable mat.

A fourth embodiment of an electronic collar and base system has a plurality of collars paired with one base.

A fifth embodiment of an electronic collar and base system has one collar paired with a plurality of bases.

A sixth embodiment of an electronic collar and base system includes audible tone within the auditory range of the pet or vibration or both when a pet approaches the base and before a shock is administered.

### Advantages

Accordingly several advantages of one or more aspects are as follows: to provide a collar which in combination with a base uses a vibration, audio tone, or shock to keep a first pet from entering an area defined by the base and thus from eating a second pet's food which could be medicated or otherwise unsuitable for the first pet. Some pets could become hypoglycemic if they do not eat their own food and may be finicky, so it is important that an owner be able to put out the food for the day and know that another pet will not eat it. The base could be placed under a table to keep the pet from that defined area. The base could be put in a doorway to prevent pets from accessing a room, for example a baby's room where a cat might suffocate a baby or a dog might wake a baby. Two systems could be used together to ensure that two pets eat their own food. The base could be attached to a TV tray or trash can that pets might get into. This invention modifies the pet's behaviors without requiring human involvement and oversight. In the case of a cat and a dog pet, the cat could be fed on the floor without the dog eating the cat's food, so the owner would not have to feed the cat on a kitchen counter or other high surface where people eat. Other advantages of one or more aspects will be apparent from a consideration of the drawings and ensuing description.

### BRIEF DESCRIPTION OF THE DRAWINGS

FIG. 1 is a schematic representation of the electrical components of the system of one embodiment of the present invention.

FIG. 2 is a top view of an electronic training collar and base system of the present invention.

FIG. 3 is a schematic representation of the electrical components of the system of a second embodiment of the present invention.

FIG. 4 is a top view of a third embodiment of an electronic training collar and base system of the present invention in which the base is shaped like a durable, hand washable mat.

FIG. 5 is a perspective view of the combination of at least one electronic training collar paired with a single base.

FIG. 6 is a perspective view of the combination one training collar paired with at least one base.

FIG. 7 is a top view of a fifth embodiment of an electronic training collar and base system in which the pet receives an audible tone within the auditory range of the pet or vibration as a warning when the pet gets within a particular distance and then a shock if the pet gets within a second particular distance of the base.

FIG. 8 shows the use of a combination of two electronic training collar and base systems so that two pets will each eat from their respective mat.

### DETAILED DESCRIPTION OF THE PREFERRED EMBODIMENT

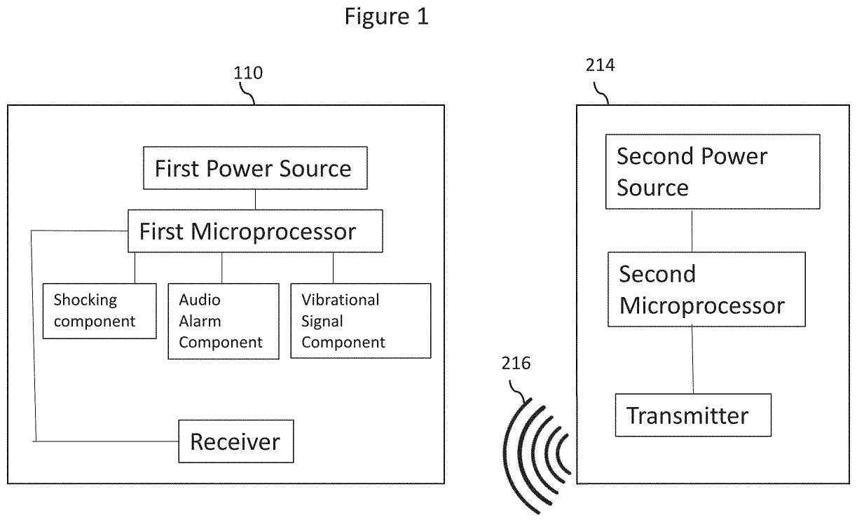

FIG. 1 shows a collar band housing 110 in which a first microprocessor is operatively connected to a shocking component. The first microprocessor is connected to a first power source which could be a battery or a rechargeable battery. The first power source is also stored in the collar band housing. FIG. 1 also shows a base 214 which contains a second power source which could be a battery or rechargeable battery and a transmitter. A second microprocessor may also be contained in the base 214. The second microprocessor is operatively connected to the second power source and a transmitter. The transmitter sends a signal 216 which is received by the receiver in the collar band housing 110. The first microprocessor then triggers either a shocking component, an audio alarm component or a vibrational signal component.

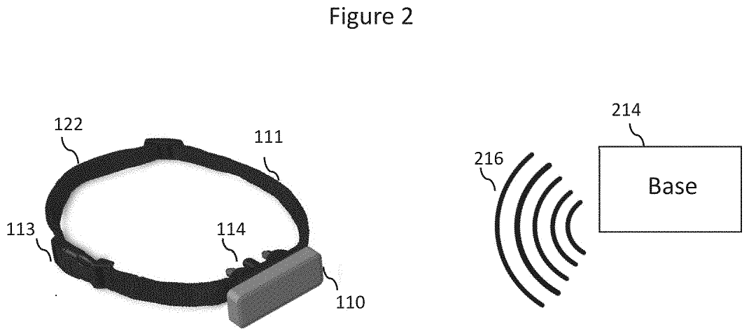

As shown in FIG. 2, the electronic training collar 122 and base 214 system features a collar band 111 for securing around the neck of a pet via a first attachment means 113, for example a buckle, a snap, a clasp, a button, etc. The collar band housing 110 for housing various electrical components is disposed on the collar band 111. The collar band housing has an inner surface, an outer surface, and an inner cavity. A shocking component is disposed on the inner surface of the housing. An audio alarm component and a vibrational signal component are disposed in the inner cavity of the collar band housing. The base 214 contains means to transmit a signal 216 which triggers an alert 114 which could be an audio signal, vibration, or shock. Shocking components, audio signals, and vibrations are well known to one of ordinary skill in the art. Transmitter-receiver systems are well known to one of ordinary skill in the art.

The first microprocessor is adapted to receive a first receiver signal from the receiver when the receiver receives the transmitter signal. Upon receipt of the first receiver signal, the microprocessor is configured to send an alert signal to the audio alarm component or the vibrational signal component to send an alert that is audible to the pet or a vibration that is felt by the pet, respectively for a length of time. The first microprocessor is further adapted to receive a second receiver signal from the receiver and to deliver an alert output command to the shocking component at an adjustable level or intensity for an adjustable length of time.

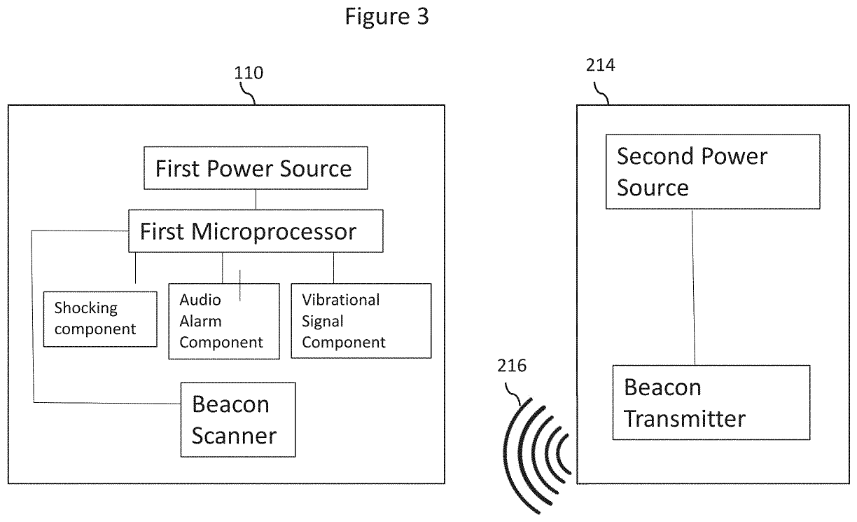

FIG. 3 shows a second embodiment of an electronic training collar 122 and base 214 system. A beacon transmitter (e.g., Bluetooth, or Bluetooth low energy) and a second power source are disposed in a base 214. The second power source is operatively connected to the beacon transmitter (e.g., Bluetooth, or Bluetooth low energy) which emits a signal 216. The collar housing 110 contains a first power source which could be a battery or a rechargeable battery. The collar housing 110 contains a first microprocessor operatively connected to a shocking component, an audio alarm component, a vibrational signal component, and a beacon scanner (e.g., Bluetooth or Bluetooth low energy). When the beacon scanner receives a signal from the beacon transmitter, the microprocessor then triggers either a shocking component, an audio alarm component or a vibrational signal component.

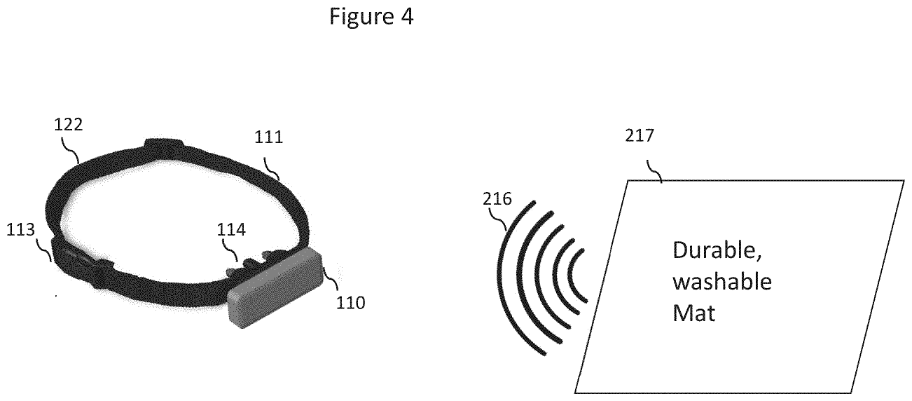

FIG. 4 shows a third embodiment of an electronic training collar 122 and base 214 system wherein the base 214 is shaped like a mat 217 which has a mat first edge, an opposing mat second edge, a mat posterior edge, a mat anterior edge, a mat top surface, and a mat bottom surface wherein the mat bottom surface is designed to interface with a ground surface; a microprocessor operatively connected to a power source and a transmitter, wherein the microprocessor, power source, and transmitter are disposed in the mat. The mat is made of a durable, hand washable material. The transmitter issues a transmission 216 to an electronic training collar. The electronic training collar 122 consists of a collar band 111 for securing around the neck of a pet via a first attachment means 113, for example a buckle, a snap, a clasp, a button, etc. The collar band housing 110 for housing various electrical components is disposed on the collar band 111. The collar band housing 110 has an inner surface, an outer surface, and an inner cavity, A shocking component is disposed on the inner surface of the housing. An audio alarm component and a vibrational signal component are disposed in the inner cavity of the collar housing. The base 214 contains means to transmit a signal 216 which triggers an alert 114 which could be an audio signal, vibration, or shock. Food could be placed in a bowl or directly on the mat. The base could also be small and attachable, for example to a table or a tray to keep pets away from the table or tray.

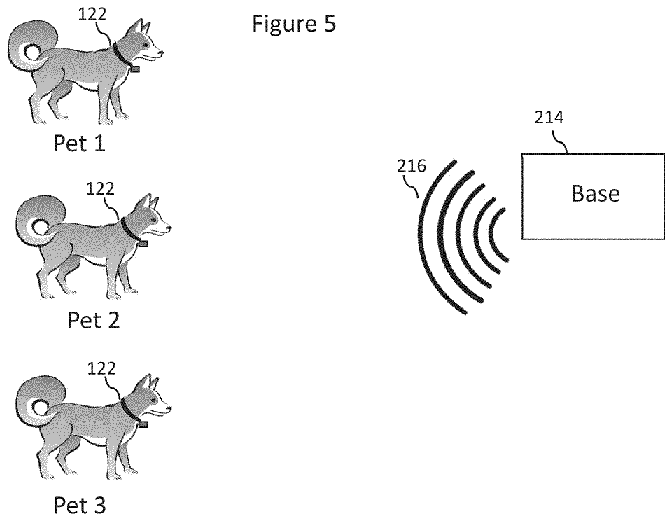

FIG. 5 shows a fourth embodiment of an electronic training collar 122 and base 214 system wherein a plurality of electronic training collars worn by pets 1, pet 2, and pet 3 is paired with one base 214 which transmits a signal 216. Pairing is a term well known by those reasonably skilled in the art,

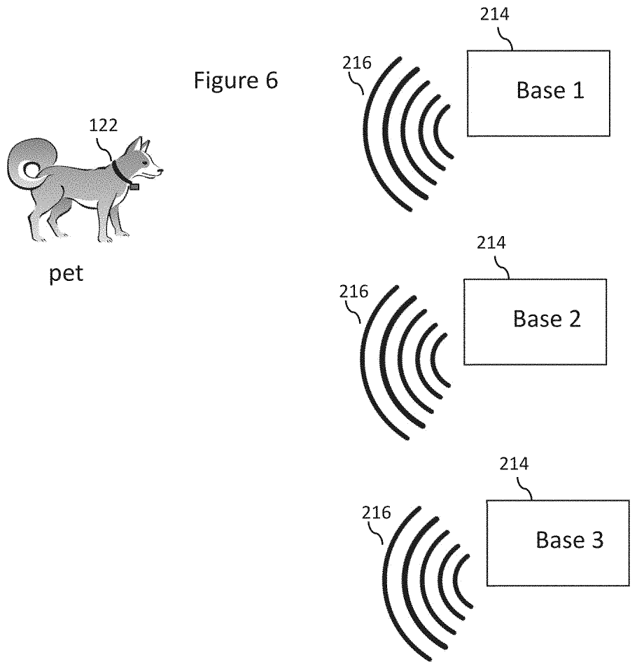

FIG. 6 shows a fifth embodiment of an electronic training collar 122 and base 214 system wherein a plurality of bases 214 are paired with one electronic training collar 122 worn by a pet. The bases 214 could be strategically placed so that the pet wearing the electronic training collar 122 is excluded from a more extensive area.

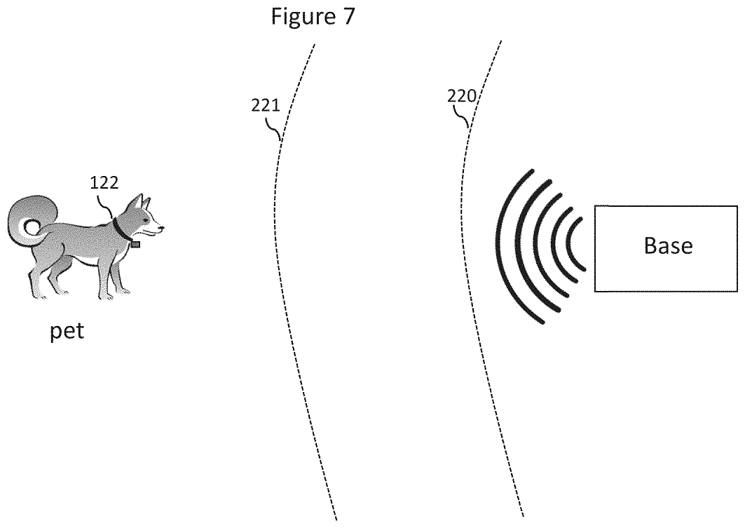

FIG. 7 shows a sixth embodiment of an electronic training collar 122 and base 214 system wherein when the pet wearing the electronic training collar 122 enters within a particular first distance 221, which could be five feet, the electronic training collar 122 issues a warning vibration or audible tone within the auditory range of the pet. If the pet wearing the electronic training collar 122 then enters within a particular second distance 220, which could be 1 foot, the electronic training collar 122 emits a shock.

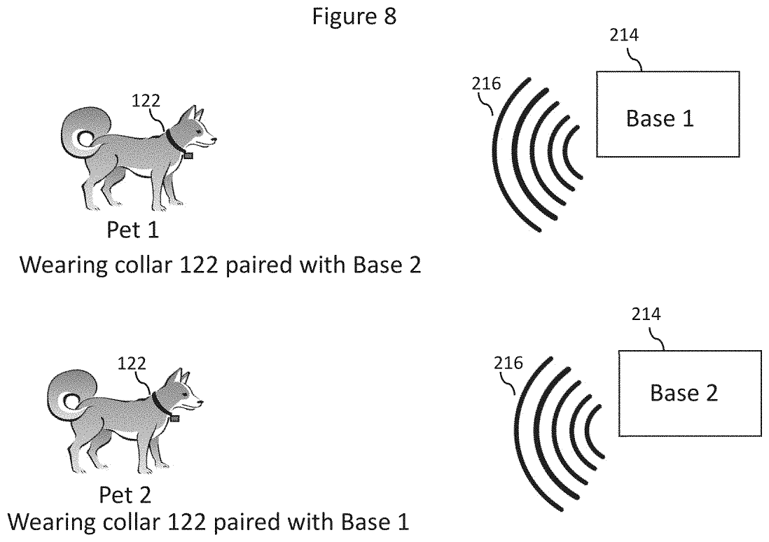

FIG. 8 shows the use of a combination of two electronic training collar 122 and base 214 systems so that two pets will each eat from their respective bowl or food placed directly on the mat. A pet 1 is deterred from eating from base two 214 and a pet 2 is deterred from eating from base one 214. Pet 1 is wearing an electronic training collar 122 which is paired with base two 214. Pet 2 is wearing an electronic training collar 122 which is paired with base one 214. Base one and electric training collar on pet 2 are color coded to match. Base two and the electric training collar on pet 1 are color coded to match with a different color.

Although there has been shown and described the preferred embodiments of the present invention, it will be readily apparent to those skilled in the art that modifications may be made thereto which do not exceed the scope of the appended claims. Therefore, the scope of the invention is only to be limited by the following claims.

I claim:

1. an electronic training collar and base system comprising:
(a) a collar band for securing around the neck of a pet by an attachment means, wherein a housing is disposed on the collar band, the housing having an outer surface, an inner surface, and an inner cavity, wherein a shocking component is disposed on the inner surface of the housing and a first microprocessor, an alert component, a first power source, and a receiver component, wherein the microprocessor is operatively connected to the shocking component, the alert component, and the receiver component, and the first power source, the shocking component is adapted to emit a shock when activated; and
(b) a base wherein a transmitter component and a second power source are disposed in the base, the transmitter component is operatively connected to the second power source;
wherein the first microprocessor is adapted to receive a receiver signal from the receiver component when the receiver component receives the transmitter signal from the transmitter component, wherein upon receipt of the transmitter signal the first microprocessor is configured to either send an alert via the alert component at a particular level for a particular length of time, or send a command to the shocking component to activate the shocking component for a particular length of time.

2. The electronic training collar and base system of claim 1 wherein the base also contains a microprocessor, said microprocessor being operatively connected to the second power source and the transmitter.

3. The electronic training collar and base system of claim 1 wherein the alert component is a vibrating component adapted to emit a vibration when activated.

4. The electronic training collar and base system of claim 1 wherein the alert component is a sound component adapted to emit a tone when activated.

5. The electronic training collar and base system of claim 1 wherein the first power source or the second power source is rechargeable.

6. The electronic training collar and base system of claim 1 wherein there is at east one base paired with at least one collar.

7. The electronic training collar and base system of claim 1 wherein the base is a mat having a mat first edge, an opposing mat second edge, a mat posterior edge, a mat anterior edge, a mat top surface, and a mat bottom surface wherein the mat bottom surface is designed to interface with a ground surface a microprocessor operatively connected to a power source and a transmitter, wherein the microprocessor, power source, and transmitter are disposed in the mat base.

8. The electronic training collar and base system of claim 1 in which the pet receives an audible tone within the auditory range of the pet or a vibration as a warning when the pet gets within a first particular distance and then a shock if the pet gets within a second particular distance of the base.

9. The electronic training collar and base system of claim 1 wherein the base and the electronic training collar are color coded when paired.

10. An electronic training collar and base system comprising:
(a) a collar band for securing around the neck of a pet by an attachment means, wherein a housing is disposed on the collar band, the housing having an outer surface, an inner surface, and an inner cavity, wherein a shocking component is disposed on the inner surface of the housing and a microprocessor, an alert component, a first power source, and a beacon scanner, wherein the microprocessor is operatively connected to the shocking component, the alert component, the beacon scanner, and the first power source, the shocking component is adapted to emit a shock when activated; and
(b) a base wherein there is a beacon transmitter operatively connected to a second power source;
wherein upon receipt of the beacon transmitter signal the microprocessor is configured to either send an alert via the alert component at a particular level for a particular length of time, or send a command to the shocking component to activate the shocking component for a particular length of time.

11. The electronic training collar and base system of claim 10 wherein the alert component is a vibrating component adapted to emit a vibration when activated.

12. The electronic training collar and base system of claim 10 wherein the alert component is a sound component adapted to emit a tone when activated.

13. The electronic training collar and base system of claim 10 wherein the first power source or the second power source is rechargeable.

14. The electronic training collar and base system of claim 10 wherein there is at least one base paired with at least one electronic training collar.

15. The electronic training collar and base system of claim 10 wherein the base is a mat having a mat first edge, an opposing mat second edge, a mat posterior edge, a mat anterior edge, a mat top surface, and a mat bottom surface wherein the mat bottom surface is designed to interface with a ground surface; a beacon transmitter operatively, connected to a power source, wherein the beacon transmitter and the second power source are disposed in the mat base.

16. The electronic training collar and base system of claim 10 in which the pet receives an audible tone within the auditory range of the pet or vibration as a warning when the pet gets within a first particular distance and then a shock if the pet gets within a second particular distance of the base.

17. The electronic training collar and base system of claim 10 wherein the base and the electronic training collar are color coded when paired.
